(19) United States
(12) Patent Application Publication
(10) Pub. No.: US 2019/0064550 A1
(43) Pub. Date: Feb. 28, 2019

(54) Alerting Eyewear Device

(71) Applicant: Logan Bush, Castlewood, VA (US)

(72) Inventor: Logan Bush, Castlewood, VA (US)

(21) Appl. No.: 15/690,319

(22) Filed: Aug. 30, 2017

(51) Int. Cl. G02C 11/00; G02C 11/04; G08B 5/36; G02B 27/01; H04N 7/18

(52) U.S. Cl. CPC G02C 11/10; G02C 11/04; H04N 7/185; G02B 27/017; G08B 5/36

(57) ABSTRACT

An alerting eyewear device for enhancing driver alertness includes spectacles that comprise a frame. The spectacles are configured to selectively position over eyes of a user. A housing is coupled to the frame. A power module, a microprocessor, a transmitter, and a camera are coupled to the housing. The microprocessor is operationally coupled to the power module. The camera, the transmitter and at least one bulb, which is coupled to the frame, are operationally coupled to the microprocessor. The camera is configured to capture and to relay facial images to the microprocessor. The microprocessor is positioned to monitor changes in the facial images to determine awareness of the user and to compel the transmitter to signal a receiver of the vehicle to compel a radio of the vehicle to sound an auditory alert, and to selectively compel the at least one bulb to illuminate, to rouse the user.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art including information disclosed under 37 CFR 1.97 and 1.98

The disclosure and prior art relates to eyewear devices and more particularly pertains to a new eyewear device for enhancing driver alertness.

### BRIEF SUMMARY OF THE INVENTION

An embodiment of the disclosure meets the needs presented above by generally comprising spectacles that comprise a frame. The spectacles are configured to selectively position over eyes of a user. A housing is coupled to the frame. A power module, a microprocessor, a transmitter, and a camera are coupled to the housing. The microprocessor is operationally coupled to the power module. The camera, the transmitter and at least one bulb, which is coupled to the frame, are operationally coupled to the microprocessor. The camera is configured to capture and to relay facial images to the microprocessor. The microprocessor is positioned to monitor changes in the facial images to determine awareness of the user and to compel the transmitter to signal a receiver of the vehicle to compel a radio of the vehicle to sound an auditory alert, and to selectively compel the at least one bulb to illuminate, to rouse the user.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top view of an alerting eyewear device according to an embodiment of the disclosure.

FIG. 2 is a back view of an embodiment of the disclosure.

FIG. 3 is a bottom view of an embodiment of the disclosure.

FIG. 4 is a detail view of an embodiment of the disclosure.

FIG. 5 is a detail view of an embodiment of the disclosure.

FIG. 6 is an in-use view of an embodiment of the disclosure.

### DETAILED DESCRIPTION OF THE INVENTION

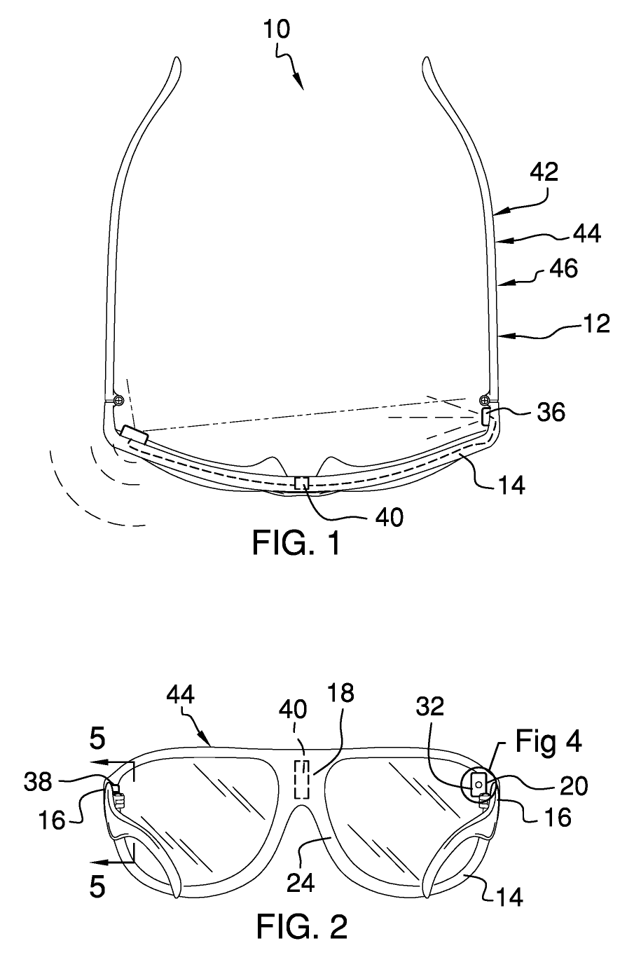

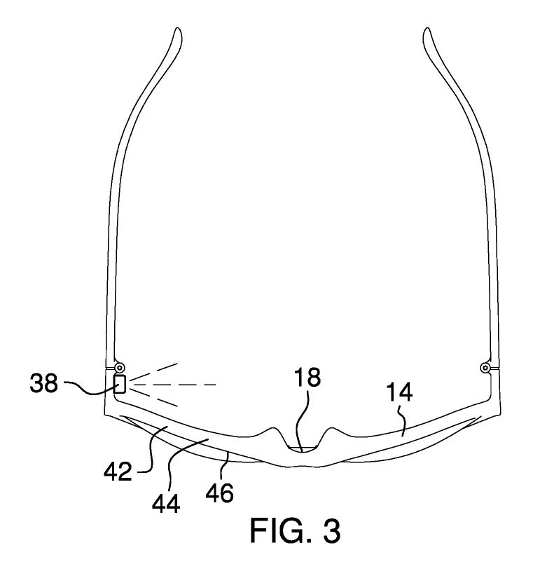

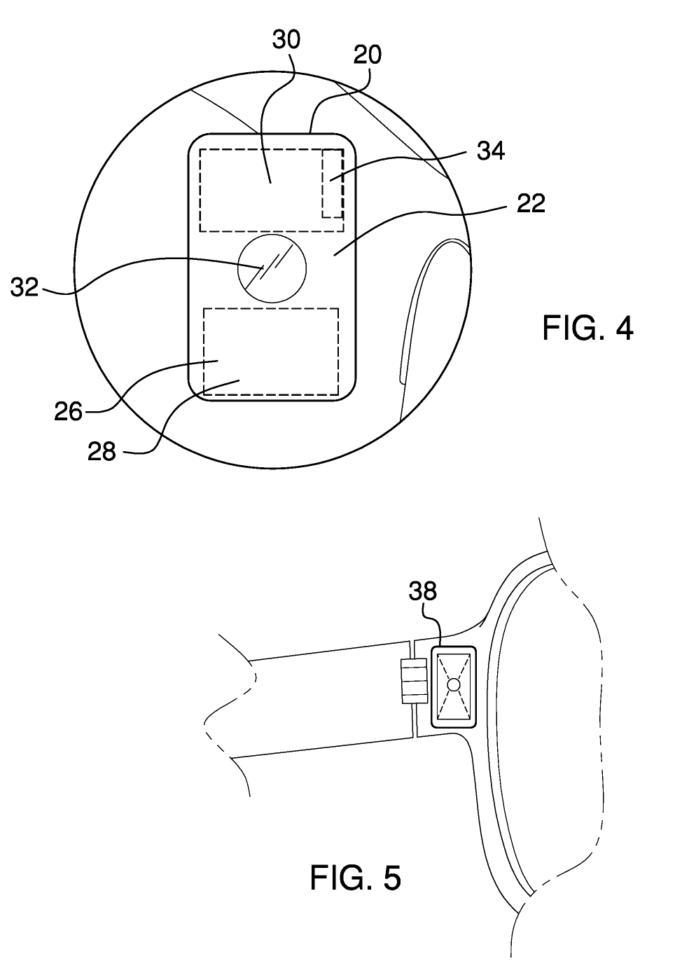

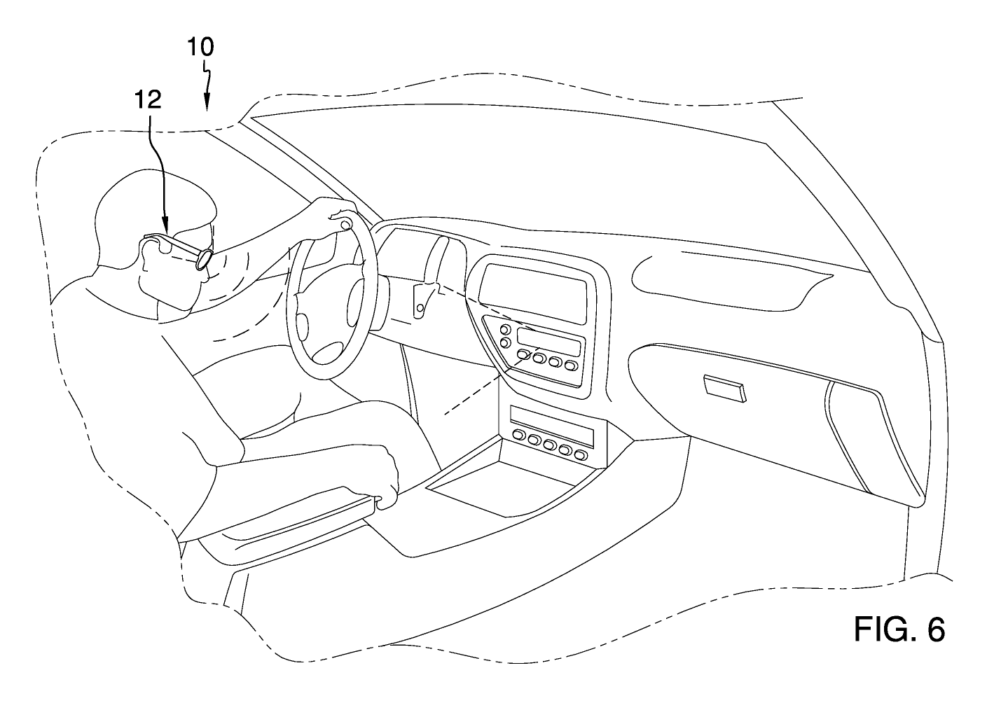

With reference now to the drawings, and in particular to FIGS. 1 through 6 thereof, a new eyewear device embodying the principles and concepts of an embodiment of the disclosure and generally designated by the reference numeral 10 will be described.

As best illustrated in FIGS. 1 through 6, the alerting eyewear device 10 generally comprises spectacles 12 that comprise a frame 14, which has opposing end 16. The spectacles 12 are configured to selectively position over eyes of a user to position a nosepiece 18 of the frame 14 on a nose of the user.

A housing 20 that defines an interior space 22 is coupled to the frame 14. In one embodiment, the housing 20 is positioned on an inside face 24 of the frame 14 and proximate to a respective opposing end 16 of the frame 14. In another embodiment, the housing 20 is substantially rectangularly box shaped.

A power module 26 is coupled to the housing 20 and is positioned in the interior space 22. In one embodiment, the power module 26 comprises at least one battery 28. A microprocessor 30 is coupled to the housing 20 and is positioned in the interior space 22. The microprocessor 30 is operationally coupled to the power module 26.

A camera 32 is coupled to the housing 20. The camera 32 is operationally coupled to the microprocessor 30. The camera 32 is configured to capture facial images and to relay the facial images to the microprocessor 30. The microprocessor 30 is positioned to monitor changes in the facial images to determine a level of awareness of the user while the user is driving a vehicle.

A transmitter 34 is coupled to the housing 20 and is positioned in the interior space 22. The transmitter 34 is operationally coupled to the microprocessor 30 and to a receiver of the vehicle. The microprocessor 30 is positioned to selectively compel the transmitter 34 to signal the receiver of the vehicle to compel powering on of a radio of the vehicle to sound an auditory alert if the level of awareness of the user drops below a threshold level. The auditory alert serves to rouse the user. In one embodiment, the transmitter 34 is Bluetooth enabled.

At least one bulb 36 is coupled to the frame 14 and is operationally coupled to the microprocessor 30. The microprocessor 30 is positioned to selectively compel the at least one bulb 36 to illuminate if the level of awareness of the user drops below the threshold level. Illumination of the at least one bulb 36 serves to rouse the user. In one embodiment, the microprocessor 30 is configured to compel intermittent illumination of the at least one bulb 36. In another embodiment, the at least one bulb 36 comprises a light emitting diode 38. In yet another embodiment, the light emitting diode 38 is positioned distally from the housing 20 and proximate to a respective opposing end 16 of the frame 14.

A vibrator 40 is coupled to the frame 14 and is operationally coupled to the microprocessor 30. The microprocessor 30 is positioned to selectively compel the vibrator 40 to vibrate if the level of awareness of the user drops below the threshold level. The vibration of the vibrator 40 serves to rouse the user. In one embodiment, the vibrator 40 is positioned on the nosepiece 18.

In one embodiment of the invention, the spectacles 12 comprise sunglasses 42. In another embodiment of the invention, the spectacles 12 comprise prescription glasses 44. In yet another embodiment of the invention, the spectacles 12 comprise prescription sunglasses 46.

In use, the camera 32 is configured to capture the facial images and to relay the facial images to the microprocessor 30. The microprocessor 30 is positioned to monitor changes in the facial images to determine the level of awareness of the user while the user is driving the vehicle. If the level of awareness of the user drops below the threshold level, the microprocessor 30 is positioned to selectively compel the transmitter 34 to signal the receiver of the vehicle to compel powering on of the radio of the vehicle to sound the auditory alert. The microprocessor 30 also is positioned to selectively compel the light emitting diode 38 to illuminate intermittently if the level of awareness of the user drops below the threshold level. The microprocessor 30 also is positioned to selectively compel the vibrator 40 to vibrate if the level of awareness of the user drops below the threshold level. The auditory alert, the intermittent illumination of the light emitting diode 38, and the vibration of the vibrator 40 serve to rouse the user.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. An alerting eyewear device comprising:
spectacles comprising a frame having opposing end, said spectacles being configured for selectively positioning over eyes of a user positioning a nosepiece of said frame on and extending upwardly from a nose and between the eyes of the user;
a housing defining an interior space, said housing being coupled to said frame;
a power module being coupled to said housing and positioned in said interior space;
a microprocessor coupled to said housing and positioned in said interior space, said microprocessor being operationally coupled to said power module;
a camera coupled to said housing, said camera being operationally coupled to said microprocessor, said camera being configured for capturing facial images and for relaying the facial images to said microprocessor;
a transmitter being coupled to said housing and positioned in said interior space, said transmitter being operationally coupled to said microprocessor and to a receiver of the vehicle;
at least one bulb coupled to said frame, said at least one bulb being operationally coupled to said microprocessor;
wherein said camera is positioned on said housing such that said camera is configured for capturing the facial images and for relaying the facial images to said microprocessor such that said microprocessor is positioned for monitoring changes in the facial images for determining a level of awareness of the user while driving a vehicle, wherein said transmitter is positioned in said housing such that said microprocessor is positioned for selectively compelling said transmitter for signaling the receiver of the vehicle for compelling powering on of a radio of the vehicle for sounding an auditory alert in the event of the level of awareness of the user dropping below a threshold level for rousing the user, wherein said at least one bulb is positioned on said frame such that said microprocessor is positioned for selectively compelling said at least one bulb for illuminating in the event of the level of awareness of the user dropping below the threshold level for rousing the user; and
a vibrator coupled to said frame, said vibrator being operationally coupled to said microprocessor, wherein said vibrator is positioned on said frame such that said microprocessor is positioned for selectively compelling said vibrator for vibrating in the event of the level of awareness of the user dropping below the threshold level for rousing the user, said vibrator being positioned on said nosepiece wherein said vibrator is positioned to extend upwardly from the nose and between the eyes of the user.

2. The device of claim 1, further including said housing being positioned on an inside face of said frame proximate to a respective said opposing end of said frame.

3. The device of claim 1, further including said housing being substantially rectangularly box shaped.

4. The device of claim 1, further including said power module comprising at least one battery.

5. The device of claim 1, further including said transmitter being enabled for use in a personal access network.

6. The device of claim 1, further including said microprocessor being configured for compelling intermittent illumination of said at least one bulb.

7. The device of claim 1, further including said at least one bulb comprising a light emitting diode.

8. The device of claim 7, further including said light emitting diode being positioned distally from said housing proximate to a respective said opposing end of said frame.

9. (canceled)

10. (canceled)

11. The device of claim 1, further including said spectacles comprising sunglasses.

12. The device of claim 1, further including said spectacles comprising prescription glasses.

13. The device of claim 12, further including said spectacles comprising prescription sunglasses.

14. An alerting eyewear device comprising:
spectacles comprising a frame having opposing end, said spectacles being configured for selectively positioning over eyes of a user positioning a nosepiece of said frame on and extending upwardly from a nose and between the eyes of the user;
a housing defining an interior space, said housing being coupled to said frame, said housing being positioned on an inside face of said frame proximate to a respective said opposing end of said frame, said housing being substantially rectangularly box shaped;
a power module being coupled to said housing and positioned in said interior space, said power module comprising at least one battery;
a microprocessor coupled to said housing and positioned in said interior space, said microprocessor being operationally coupled to said power module;
a camera coupled to said housing, said camera being operationally coupled to said microprocessor, said camera being configured for capturing facial images and for relaying the facial images to said microprocessor, wherein said camera is positioned on said housing such that said camera is configured for capturing the facial images and for relaying the facial images to said microprocessor such that said microprocessor is positioned for monitoring changes in the facial images for determining a level of awareness of the user while driving a vehicle;
a transmitter being coupled to said housing and positioned in said interior space, said transmitter being operationally coupled to said microprocessor and to a receiver of the vehicle, wherein said transmitter is positioned in said housing such that said microprocessor is positioned for selectively compelling said transmitter for signaling the receiver of the vehicle for compelling powering on of a radio of the vehicle for sounding an auditory alert in the event of the level of awareness of the user dropping below a threshold level for rousing the user, said transmitter being enabled for use in a personal access network;
at least one bulb coupled to said frame, said at least one bulb being operationally coupled to said microprocessor, wherein said at least one bulb is positioned on said frame such that said microprocessor is positioned for selectively compelling said at least one bulb for illuminating in the event of the level of awareness of the user dropping below the threshold level for rousing the user, said microprocessor being configured for compelling intermittent illumination of said at least one bulb, said at least one bulb comprising a light emitting diode, said light emitting diode being positioned distally from said housing proximate to a respective said opposing end of said frame;
a vibrator coupled to said frame, said vibrator being operationally coupled to said microprocessor, wherein said vibrator is positioned on said frame such that said microprocessor is positioned for selectively compelling said vibrator for vibrating in the event of the level of awareness of the user dropping below the threshold level for rousing the user, said vibrator being positioned on said nosepiece wherein said vibrator is positioned to extend upwardly from the nose and between the eyes of the user; and
wherein said camera is positioned on said housing such that said camera is configured for capturing the facial images and for relaying the facial images to said microprocessor such that said microprocessor is positioned for monitoring changes in the facial images for determining the level of awareness of the user while driving the vehicle, wherein said transmitter is positioned in said housing such that said microprocessor is positioned for selectively compelling said transmitter for signaling the receiver of the vehicle for compelling powering on of the radio of the vehicle for sounding the auditory alert in the event of the level of awareness of the user dropping below the threshold level for rousing the user, wherein said light emitting diode is positioned on said frame such that said microprocessor is positioned for selectively compelling said light emitting diode for intermittently illuminating in the event of the level of awareness of the user dropping below the threshold level for rousing the user, wherein said vibrator is positioned on said frame such that said microprocessor is positioned for selectively compelling said vibrator for vibrating in the event of the level of awareness of the user dropping below the threshold level for rousing the user.

15. The device of claim 14, further including said spectacles comprising sunglasses.

16. The device of claim 14, further including said spectacles comprising prescription glasses.

17. The device of claim 16, further including said spectacles comprising prescription sunglasses.
